(19) United States
(12) Patent Application Publication
(10) Pub. No.: US 2005/0243018 A1
(43) Pub. Date: Nov. 3, 2005

(54) Method and system for outdoor advertising

(76) Inventor: Avraham Ben-Horesh, Holon (IL)

Correspondence Address: Dan Haendel, 8900 Lynnhurst Drive, Fairfax, VA, 22031, US

(21) Appl. No.: 10/833,016

(22) Filed: Apr. 28, 2004

(51) Int. Cl. G09G 5/00

(52) U.S. Cl. 345/1.3

(57) ABSTRACT

A method and a system for projecting messages, advertisements and other multimedia creations on semitransparent surfaces wherein a mirror image is projected on one side and the correct image is visible to the general public from the second side.

### FIELD OF INVENTION

Present invention is related to the general outdoor advertising. The goal is to utilize existing transparent or semitransparent surfaces for display of advertisements.

### SUMMARY OF THE INVENTION

I propose a method for projecting messages, commercials and other multimedia creations on transparent or semi transparent surfaces. This method is applicable to existing surfaces, such as windows, and screen walls, which are coating buildings. Hence, one can display high quality advertisement campaign at a very low cost. Moreover, since our approach works for highly visible places (e.g. walls of high rise buildings), it would be possible to reach wide sections of the general public.

The system requires at least one space, bounded by at least one transparent, or semi transparent surface (used as a display screen), at least one screen (added in case of transparent surface), at least one processor (that serves for control and content preparation), and at least one data and video projector.

In cases when display surface is transparent, a semitransparent screen is placed between the projector and the surface (as close as possible to the surface). The mirrored images are projected onto the screen. For instance, if one wishes to display advertisements on transparent office windows then, each night, the surface will be covered by semitransparent shades. Mirrored images will be projected on these shades so that the original orientation of images will be visible from the outside through the surfaces.

### BACKGROUND OF THE INVENTION

Outdoor advertising is one of the main ways to spread commercial messages. Bill-board announcements as well as other multimedia tools are widely used for this purpose. Specifically, existing technological solutions include:

1. Printed Products: Messages/Photographs are Printed on Paper and Mounted on:

1.1. Permanent or changing billboards in various shapes and sizes.
1.2. Bus stops.
1.3. Different means of transportation such as buses cabs and trains.

This method calls for printing adverts on sheets of paper and mounting them on billboards and different vehicles such as buses and trains. The advertisements are displayed to the public during a fixed period of time, as agreed in the contract between the advertiser and the domain owner. At the end of the leasing period, the message is dismounted manually. This method is most commonly used. It is relatively inexpensive. However, since all changes are done manually, flexibility is very limited.

2. Printed Messages Mounted on Frames such as on:

2.1 Scaffolding.
2.2 Outer walls of buildings
2.3 Outer body of trains or buses.

In this case advertisements are printed directly on special fabrics in various shapes and sizes. Once again, the advertisements are displayed to the public during a fixed period of time, as agreed in the contract between the advertiser and the domain owner. At the end of the leasing period, the message is dismounted manually. Production costs are high and there are relatively few suitable mounting places.

3. Electric and Electronic Displays:

3.1 Electric bulbs lighting windows in high story buildings according to fixed or variable formats. In some cases electric bulbs are placed in a manner that creates text or other symbols. Frequently, processors control dynamic displays. This method is effective due to the fact that high-rise buildings are visible from afar. However, this method suffers from low image resolution, which limits message diversity and effectiveness.
3.2 LED screens.

This method uses displays that work like TV screens. Each display is constructed from thousands of colored diode units clustered on a flat surface. Hence, display of movies and other multimedia creations is possible. Content can be controlled remotely. Therefore maintenance is relatively easy. The disadvantage is in high acquisition cost (typically several hundreds of thousands of dollars for each high quality display).

Invention Description:

I propose a system for projecting messages, advertisements and other multimedia creations on transparent or semi-transparent surfaces, which are visible to the general public. Typically existing surfaces would be used. Thus cost would be reduced and flexibility would be enhanced. Therefore our method solves all the problems in the existing techniques mentioned above. It provides high quality, highly visible, flexible displays at relatively low cost.

Our method consists of the following basic elements:
1. At least one space.
2. Bounded by at least one surface, visible to the public, whose transparency/reflectivity level allows image projection.
3. In cases, where the surface is transparent and image projection is not possible, a semi transparent screen will be placed between the projector and the surface (as close as possible to the surface), so that the projected image will be created on the screen.
4.At least one data and video projector. The data and video projector is placed in a designated space, such as a room, a patio, or a dark chamber. The data and video projector is mounted in front of the surface, thus the projected mirrored image covers most of the surface opening.
5. Several processors:
   5.1 At least one main processor that prepares the content, turning it into mirrored images and distributes them to the individual display units. In addition, the main processor handles synchronization between different units so that large combined displays can be created.
   5.2 One or more local processors connected to their corresponding projectors. The local unit can operate either as an independent unit, preparing the content and sending the mirrored image to its local data and video projector, or as a slave processor receiving the content from the main processor and sending it over to its connected projector
      Possible Implementations and Alternatives:
      1. Projection on a Single Semitransparent Surface:

Both processor and the data and video projector are placed inside a space, such as a room, a hall, a shop, a patio, or a dark chamber. The data and video projector is placed opposite the surface, so that the projected mirrored image covers the maximal surface opening. The mirrored images are sent from the processor to the projector. As a result a mirror image is created on the inner side of the semitransparent surface that serves as a display screen. The original orientation of the images is viewed on the outer side of the surface, which faces the public. (See drawing no. 1).

2. Projection on a Single Transparent Surface:

This case is similar to case no 1. However, since the surface is completely transparent, it cannot serve as a display screen. This problem is overcome by placing semitransparent display screen close to the surface in question. Once again, both processor and the data and video projector are placed in a space, facing the screen. The data and video projector is placed in a proper distance so that the projected mirrored images covers the maximal surface opening. As a result mirror image is created on the semitransparent screen. Since projected image passes through the screen, it can be viewed in its original orientation, on the outer side of the surface, which faces the public. (See drawing no. 2).

3. Simultaneous Multiple Projections on Several Semitransparent Surfaces:

This case is the same as the case no 1. However multiple local processors and projectors are used simultaneously in order to create large composite displays. They are controlled by at least one main processor. In principle one can create combined effects using multiple surface displays. (See drawing no. 3).

This approach is suitable not only for advertisement but also for decoration of various buildings, monuments and other tourist attractions.

4. Simultaneous Multiple Projections on Several Transparent Surfaces:

This case is similar to case no 3. However, transparent surfaces are used instead of semitransparent ones. Multiple semitransparent screens are placed between the projectors and the transparent surface (as close as possible to the surface).

(See drawing no. 4).

5. Projection on Billboards:

Both processor and the data and video projector are placed behind a billboard, in a new-formed space like a dark chamber. The data and video projector mounted opposite a semitransparent material screen, so that the projected mirrored image covers the maximal screen opening. The mirrored image is sent from the processor to the projector. As a result a mirror image is created on the inner side of the semitransparent screen that serves as a display screen. The original orientation of the image can be viewed on the outer side of the surface, which faces the public. (See drawing no. 5).

### LIST OF DRAWINGS

FIG. 1. Projection on a single semitransparent surface.

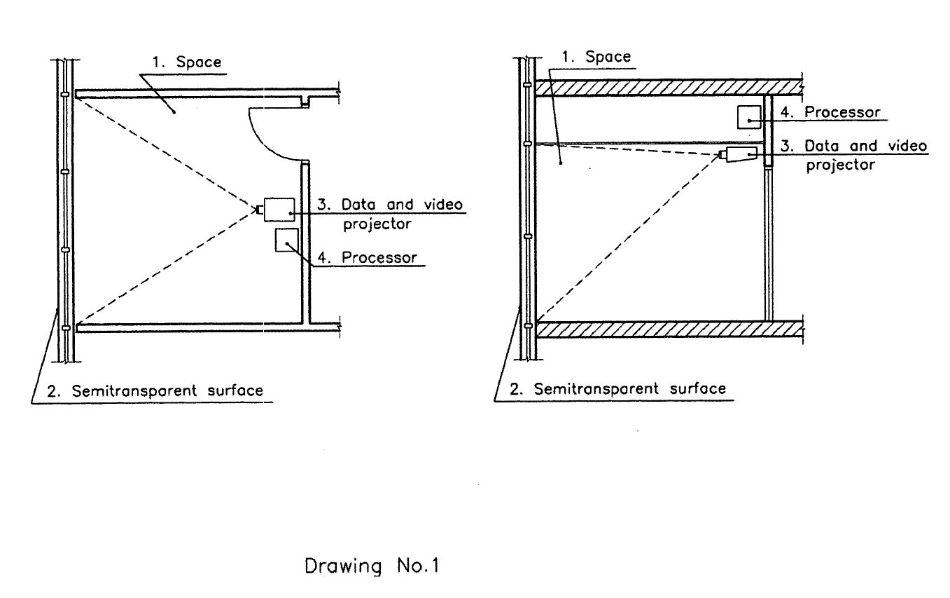

FIG. 2. Projection on a single transparent surface.

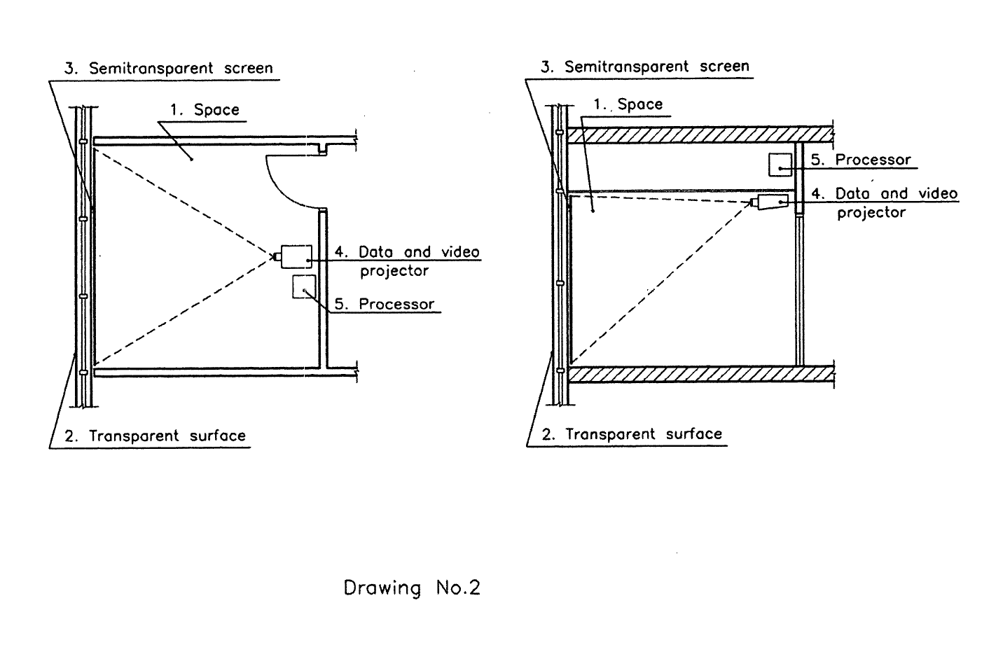

FIG. 3. Simultaneous multiple projections on several semitransparent surfaces.

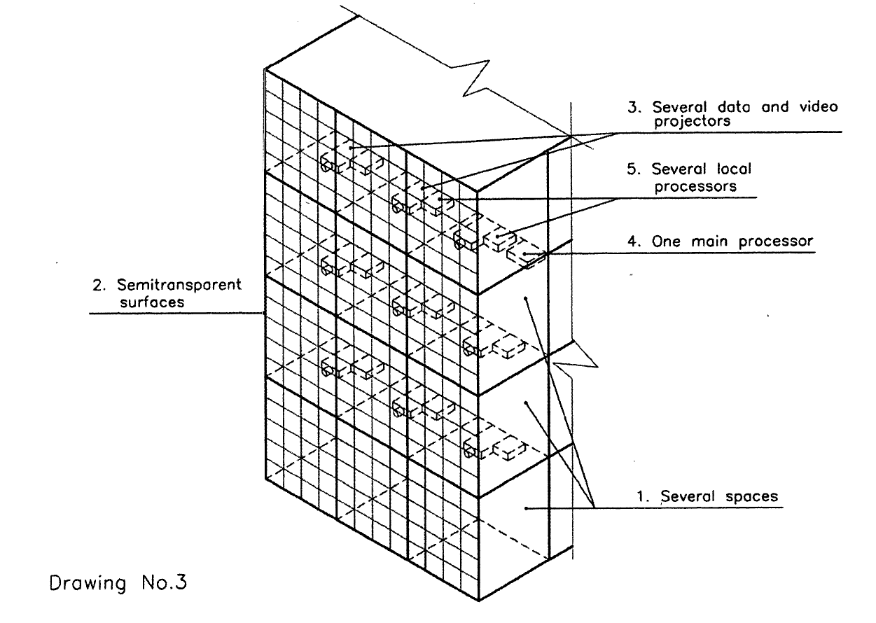

FIG. 4. Simultaneous multiple projections on several transparent surfaces.

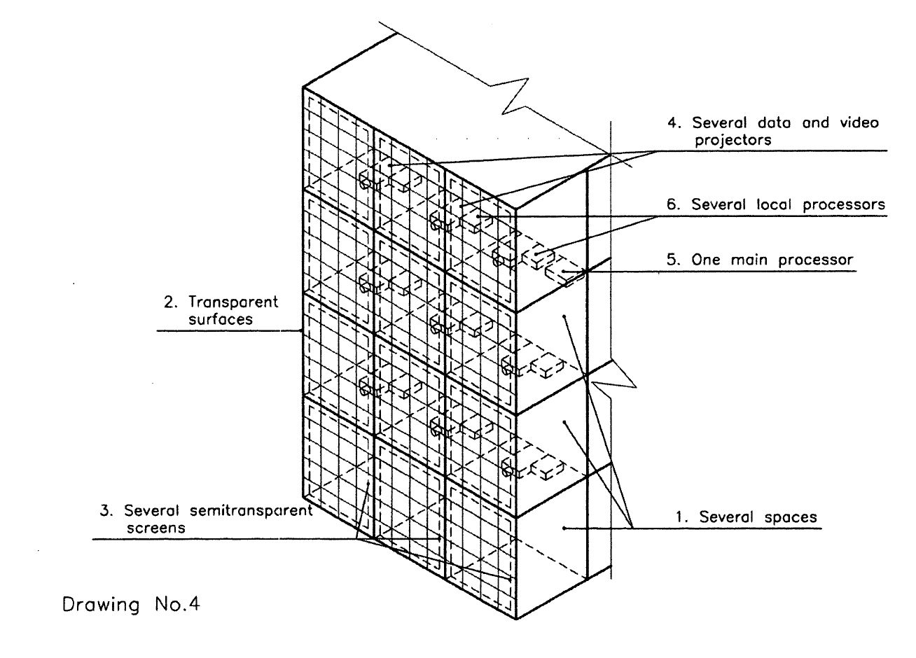

FIG. 5. Projection on billboards.

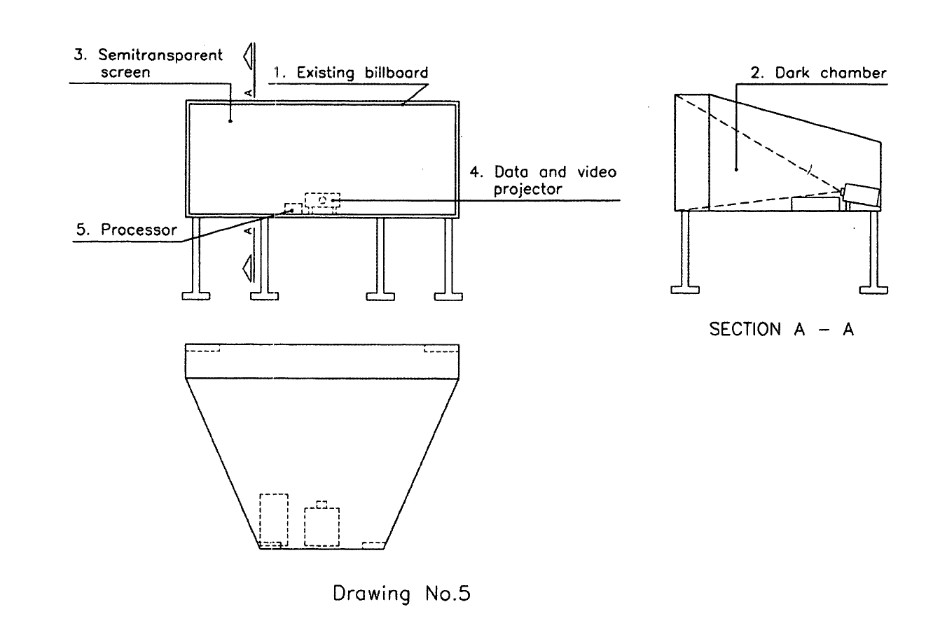

### BRIEF DESCRIPTION OF LISTED DRAWINGS

1. Projection on a Single Semitransparent Surface.

A space (1) bounded by one semitransparent surface (2), visible to the public, whose transparency level allows image projection. One data and video projector (3) and one processor (4).

2. Projection on a Single Transparent Surface.

A space (1) bounded by one transparent surface (2), visible to the public, whose transparency level does not allow image projection. One semitransparent screen (3). One data and video Projector (4) and one processor (5).

3. Simultaneous Multiple Projections On Several Semitransparent Surfaces.

Several spaces (1) bounded by semitransparent surfaces (2), visible to the public, whose transparency level allows image projection. Several data and video projectors (3). One main processor (4) and several local processors (5).

4. Simultaneous Multiple Projections on Several Transparent Surfaces.

Several spaces (1) bounded by transparent surfaces (2), visible to the public, whose transparency level does not allow image projection. Several semitransparent screens (3). Several data and video projector (4). One main processor (5) and several local processors (6).

5. Projection on Billboards.

One existing billboard (1). A new built space, which serves as a dark chamber (2), bounded by one semitransparent screen (3), visible to the public, whose transparency level allows image projection. One data and video projector (4) and one processor (5).

1. A method and a system for projecting messages, advertisements and other multimedia creations on semitransparent surfaces, such that mirror image is projected on one side and correct image is visible to the general public from the second side.

2. A method and a system according to claim 1, where projector is connected to the processor which controls the content such that images to be displayed can come either from a local data base or from the central repository.

3. A method and a system according to claim 1, where the surface is transparent and a semitransparent screen is placed between the projector and the surface, as close as possible to the surface, so that the mirror image is projected on the screen.

4. A method and a system according to claim 1, where several display surfaces are interconnected so that a large combined display is created.

5. A method and a system according to claim 4, where some display surfaces are transparent and therefore semitransparent screens are placed between the projectors and the transparent surfaces such that said screens serve as the system display surfaces.

6. A method and a system according to claim 1, where a dark chamber is built behind a semitransparent billboard, where the processor and the data and video projector are mounted opposite to the semitransparent surface, the processor receives or creates the content as mirrored images and transmits them to the projector, which projects the mirrored images onto the semitransparent surface such that the original images are seen by the public in front of the billboard.
